(19) United States
(12) Patent Application Publication
(10) Pub. No.: US 2015/0163545 A1
(43) Pub. Date: Jun. 11, 2015

(54) IDENTIFICATION OF VIDEO CONTENT SEGMENTS BASED ON SIGNATURE ANALYSIS OF THE VIDEO CONTENT

(71) Applicant: ECHOSTAR TECHNOLOGIES L.L.C., Englewood, CO (US)

(72) Inventors: James Freed, Denver, CO (US); William Beals, Englewood, CO (US); Jason Fruh, Castle Rock, CO (US); David Crandall, Aurora, CO (US)

(21) Appl. No.: 14/102,621

(22) Filed: Dec. 11, 2013

(51) Int. Cl. H04N 21/44; H04N 21/81; H04N 21/61; H04N 21/435; H04N 21/442; H04N 21/4335

(52) U.S. Cl. CPC H04N 21/44008; H04N 21/44204; H04N 21/4335; H04N 21/6143; H04N 21/435; H04N 21/812

(57) ABSTRACT

A video services receiver and related operating methods are disclosed here. In accordance with one disclosed methodology, the video services receiver receives a segment of video content, and processes a plurality of contiguous sub-segments of the segment of video content to generate a corresponding plurality of characterizing signatures. Each of the characterizing signatures identifies a respective one of the contiguous sub-segments. The video services receiver compares the characterizing signatures to video content signatures maintained in a database. When the results of the comparing satisfy predetermined matching criteria, the video services receiver initiates an operation that influences presentation attributes of the segment of video content.

### TECHNICAL FIELD

Embodiments of the subject matter described herein relate generally to video services systems. More particularly, embodiments of the subject matter relate to a technique for identifying segments of video content, such as advertisements and commercials.

### BACKGROUND

Most television viewers now receive their video signals through a content aggregator such as a cable or satellite television provider. Digital video broadcasting (DVB) systems, such as satellite systems, are generally known. A DVB system that delivers video service to a home will usually include a video services receiver, system, or device, which is commonly known as a set-top box (STB). In the typical instance, encoded television signals are sent via a cable or wireless data link to the viewer's home, where the signals are ultimately decoded in the STB. The decoded signals can then be viewed on a television or other appropriate display as desired by the viewer.

Digital video recorders (DVRs) and personal video recorders (PVRs) allow viewers to record video in a digital format to a disk drive or other type of storage medium for later playback. DVRs are often incorporated into set-top boxes for satellite and cable television services. A television program stored on a set-top box allows a viewer to perform time shifting functions, (e.g., watch a television program at a different time than it was originally broadcast). However, commercials within the recording are presented to the user when they finally get around to watching the program.

The prior art includes a number of “commercial skipping” technologies that are intended to identify the transition boundaries between video programming content (e.g., the actual desired content) and interstitial programming content (e.g., commercials and advertisements) that occur between segments of the desired video programming content. These prior art technologies typically utilize one or more pre-processing methodologies that flag, mark, or otherwise distinguish the interstitial programming content from the desired video programming content. For example, the prior art may rely on one or more of the following techniques: tagging; bookmarking; or metadata. Indeed, prior art techniques may require human operators to watch broadcast video streams while manually marking the segment boundaries that define interstitial programming content, such that the marked segments can be skipped or deleted during subsequent playback of recorded content.

Accordingly, it is desirable to have an improved methodology for automatically detecting the presence of certain video content segments. In addition, it is desirable to have an automated technique that can identify video content segments, such as commercials, in substantially real-time during live broadcast presentation of a video stream. Furthermore, other desirable features and characteristics will become apparent from the subsequent detailed description and the appended claims, taken in conjunction with the accompanying drawings and the foregoing technical field and background.

### BRIEF SUMMARY

An embodiment of a method of operating a video services receiver is presented here. The method provides a first video stream for presentation to a user, and the first video stream has a segment of video content. The method continues by processing the segment of video content to generate at least one characterizing signature that uniquely identifies the segment of video content. The method uses the at least one characterizing signature in a query against a database of video content signatures. If the query does not find the at least one characterizing signature in the database of video content signatures, the video services receiver presents the first video stream, including the segment of video content. The second video stream is presented when the query finds the at least one characterizing signature in the database of video content signatures. The second video stream represents an altered version of the first video stream.

Another embodiment of a method of operating a video services receiver is also presented here. The method receives a segment of video content, and processes a plurality of contiguous sub-segments of the segment of video content to generate a corresponding plurality of characterizing signatures. Each of the characterizing signatures identifies a respective one of the contiguous sub-segments. The method continues by comparing the characterizing signatures to video content signatures maintained in a database. When results of the comparing satisfy predetermined matching criteria, the method initiates an operation that influences presentation attributes of the segment of video content.

Also presented here is an embodiment of a video services receiver. The video services receiver includes: a receiver interface to receive data associated with video services, including a first video stream comprising a segment of video content; a display interface for a display operatively coupled to the video services receiver, the display interface facilitating presentation video streams on the display; and a processor coupled to the receiver interface and the display interface. The processor generates at least one characterizing signature that identifies the segment of video content, compares the at least one characterizing signature against video content signatures maintained in a database to obtain comparison results, and initiates an operation that influences presentation attributes of the first video stream when the comparison results satisfy predetermined matching criteria.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an embodiment of a video services broadcasting system;

FIG. 2 is a schematic representation of an embodiment of a video services receiver suitable for use in the video services broadcasting system shown in FIG. 1; and

FIG. 3 is a flow chart that illustrates an exemplary embodiment of a method of operating a video services receiver.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like. The software that performs the described functionality may reside and execute at a host device, such as a video services receiver, a mobile device, or a home entertainment component, or it may be distributed for execution across a plurality of physically distinct devices, systems, or components, as appropriate for the particular embodiment.

The following description relates to a video delivery system that is suitably configured to process audio/visual content for presentation to a user. Although the following description focuses on video content conveyed in a video stream, the subject matter may also be utilized to handle audio content conveyed in an audio stream, such as a broadcast radio program, a streaming music channel, or the like.

The exemplary embodiments described below relate to a video delivery system such as a satellite television system, a cable delivery system, an Internet-based content delivery system, or the like. The disclosed subject matter relates to a function of a video services receiver (e.g., a STB, a mobile device with video presentation and recording functionality, a suitably configured computing device, or the like). More specifically, the disclosed subject matter relates to an automated technique for identifying particular segments of video content that may appear in a video stream. In accordance with one practical embodiment, the video services receiver processes a video stream in real-time (or substantially real-time) to identify commercials, advertisements, or other interstitial video content. The identification procedure described here could be performed while the video stream is being decoded for presentation, or it could be performed while the video stream is being recorded. Moreover, the identification procedure described here could be performed as an offline background task on previously recorded content, such that the recorded content need not be subsequently analyzed and processed at the time of playback.

The automatic identification technique described herein calculates characterizing signatures of the video content, and uses the calculated signatures to query a database of signatures that are known to be indicative of interstitial video content. If predetermined matching criteria has been satisfied, then the video services receiver can take one or more actions as needed or as desired. In the context of recorded or buffered content, for example, commercials can be skipped, fast-forwarded, muted, or replaced with alternative video content. As another example, the video services receiver may perform a “channel surfing” or preview function during commercial breaks.

Notably, the video content identification techniques described herein can be performed on the fly during the broadcast or playback of a video stream, and without relying on any pre-analysis of the video stream of interest, tagging or bookmarking of different video segments in the video stream, pre-identification of video segment boundaries, or the like. Indeed, the video content identification techniques described herein can be applied to a video stream as it is being presented to a user for purposes of detecting the presence of a commercial, and advertisement, or any form of repetitive video content. Once detected, the host system (e.g., a STB) can take appropriate action to alter, modify, or otherwise influence the content being displayed to the user. Although the following description of the embodiments refers to a technique that is performed during decoding, the disclosed subject matter is not limited to such an implementation, and those skilled in the art will appreciate that the video content identification methodology can be equivalently applied to recorded content if so desired.

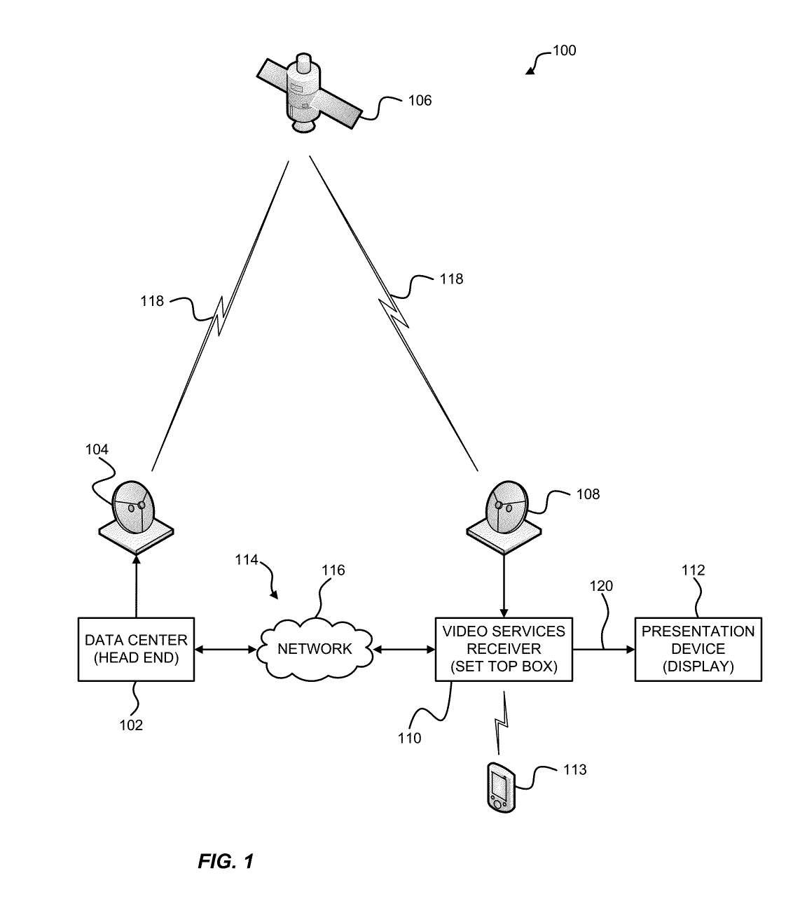

Turning now to the drawings, FIG. 1 is a schematic representation of an embodiment of a video services broadcasting system 100 that is suitably configured to support the techniques and methodologies described in more detail below. The system 100 (which has been simplified for purposes of illustration) generally includes, without limitation: a data center 102; an uplink transmit antenna 104; a satellite 106; a downlink receive antenna 108; a video services receiver 110 or other customer equipment; and a presentation device, such as a display element 112. In typical deployments, the video services receiver 110 can be remotely controlled using a wireless remote control device 113. In certain embodiments, the data center 102 communicates with the video services receiver 110 via a back-channel connection 114, which may be established through one or more data communication networks 116. For the sake of brevity, conventional techniques related to satellite communication systems, satellite broadcasting systems, DVB systems, data transmission, signaling, network control, and other functional aspects of the systems (and the individual operating components of the systems) may not be described in detail herein.

The data center 102 may be deployed as a headend facility and/or a satellite uplink facility for the system 100. The data center 102 generally functions to control content, signaling data, programming information, and other data sent over a high-bandwidth link 118 to any number of downlink receive components (only one downlink receive antenna 108, corresponding to one customer, is shown in FIG. 1). In practice, the data center 102 also provides content and data that can be used to populate an interactive electronic program guide (EPG) generated by the video services receiver 110. In the embodiment shown in FIG. 1, the high-bandwidth link 118 is a direct broadcast satellite (DBS) link that is relayed by the satellite 106, although equivalent embodiments could implement the high-bandwidth link 118 as any sort of cable, terrestrial wireless and/or other communication link as desired.

The data center 102 includes one or more conventional data processing systems or architectures that are capable of producing signals that are transmitted via the high-bandwidth link 118. In various embodiments, the data center 102 represents a satellite or other content distribution center having: a data control system for controlling content, signaling information, blackout information, programming information, and other data; and an uplink control system for transmitting content, signaling information, blackout information, programming information, and other data using the high-bandwidth link 118. These systems may be geographically, physically and/or logically arranged in any manner, with data control and uplink control being combined or separated as desired.

The uplink control system used by system 100 is any sort of data processing and/or control system that is able to direct the transmission of data on the high-bandwidth link 118 in any manner. In the exemplary embodiment illustrated in FIG. 1, the uplink transmit antenna 104 is able to transmit data to the satellite 106, which in turn uses any number of appropriately configured transponders for repeated transmission to the downlink receive antenna 108.

Under normal operating conditions, the satellite 106 transmits content, signaling data, blackout information, EPG data, and other data to the downlink receive antenna 108, using the high-bandwidth link 118. In practical embodiments, the downlink receive antenna 108 represents the customer's satellite dish, which is coupled to the video services receiver 110. The video services receiver 110 can be realized as any device, system or logic capable of receiving signals via the high-bandwidth link 118 and the downlink receive antenna 108, and capable of providing demodulated content to a customer via the display element 112.

The display element 112 may be, without limitation: a television set; a monitor; a computer display; or any suitable customer appliance with compatible display capabilities. In various embodiments, the video services receiver 110 is implemented as a set-top box (STB) as commonly used with DBS or cable television distribution systems. In other embodiments, however, the functionality of the video services receiver 110 may be commonly housed within the display element 112 itself. In still other embodiments, the video services receiver 110 is a portable device that may be transportable with or without the display element 112. The video services receiver 110 may also be suitably configured to support broadcast television reception, video game playing, personal video recording and/or other features as desired.

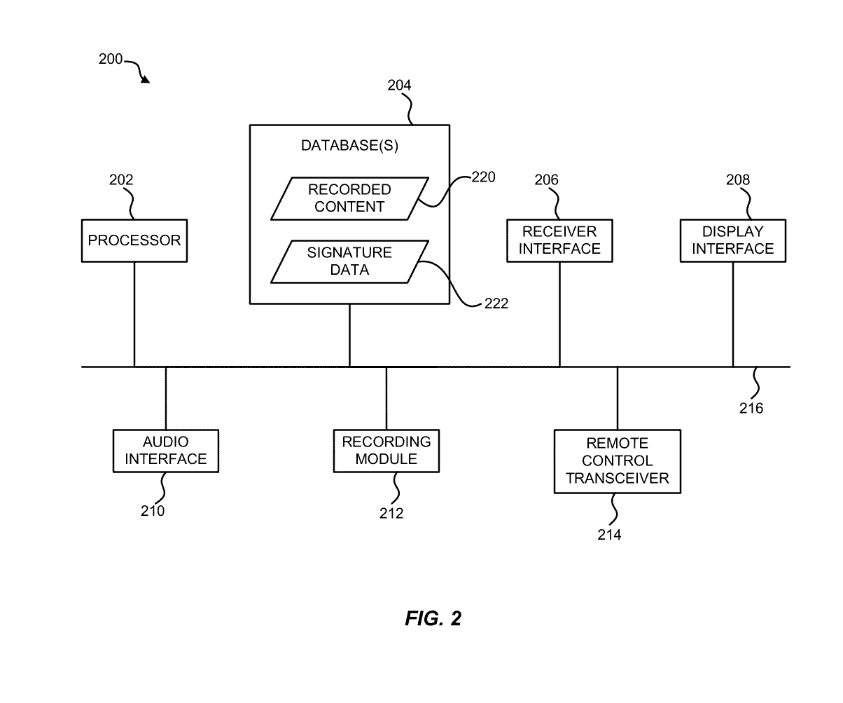

During typical operation, the video services receiver 110 receives programming (broadcast events), signaling information, and/or other data via the high-bandwidth link 118. The video services receiver 110 then demodulates, decompresses, descrambles, and/or otherwise processes the received digital data, and then converts the received data to suitably formatted video signals 120 that can be rendered for viewing by the customer on the display element 112. The video services receiver 110 may also be capable of receiving web-based content via the network 116, the Internet, etc., and may also be capable of recording and playing back video content. Additional features and functions of the video services receiver 110 are described below with reference to FIG. 2.

The system 100 includes one or more speakers, transducers, or other sound generating elements or devices that are utilized for playback of sounds during operation of the system 100. These sounds may be, without limitation: the audio portion of a video channel or program; the content associated with an audio-only channel or program; audio related to the navigation of the graphical programming guide; confirmation tones generated during operation of the system; alerts or alarm tones; or the like. Depending upon the embodiment, the system 100 may include a speaker (or a plurality of speakers) attached to, incorporated into, or otherwise associated with the display device, the video services receiver 110, the remote control device 113, and/or a home theater, stereo, or other entertainment system provided separately from the system 100.

The video services receiver 110 can be operated in a traditional manner to receive, decode, and present a first video stream for presentation to a user (i.e., a recorded or current broadcast show that the user is currently watching). Moreover, the video services receiver 110 can be operated to identify certain types video content that represent advertisements, commercials, and/or other forms of interstitial content. In certain implementations, the video services receiver 110 includes multiple tuners to enable it to concurrently receive and process the first video stream along with one or more additional video streams if needed.

Although not separately depicted in FIG. 1, the video services receiver 110 may include video place-shifting functionality or it may cooperate with a suitably configured place-shifting device or component to place-shift video content that is received by the video services receiver 110. In this regard, it may be possible to provide live or recorded content to a remote device operated by the user, wherein the video services receiver 110 serves as a source of the place-shifted content.

The system 100 may include one or more database systems, data storage devices or systems, or memory architectures that are configured and arranged as needed to support the functionality described herein. For example, the data center 102 may be provided with a suitably configured database that may be accessed by the video services receiver 110. Alternatively, or additionally, the system 100 may include or cooperate with any number of databases that can be accessed via the network 116. In this regard, the video services receiver 110 may be operatively coupled with a distributed database architecture that is supported by the network 116. Alternatively, or additionally, the video services receiver 110 may include or be directly attached to a suitably configured storage element or device that provides a local database to support the various features and functionality described here. The embodiment described below assumes that the video services receiver 110 includes a suitably configured integrated database that can be populated, maintained, and accessed as needed.

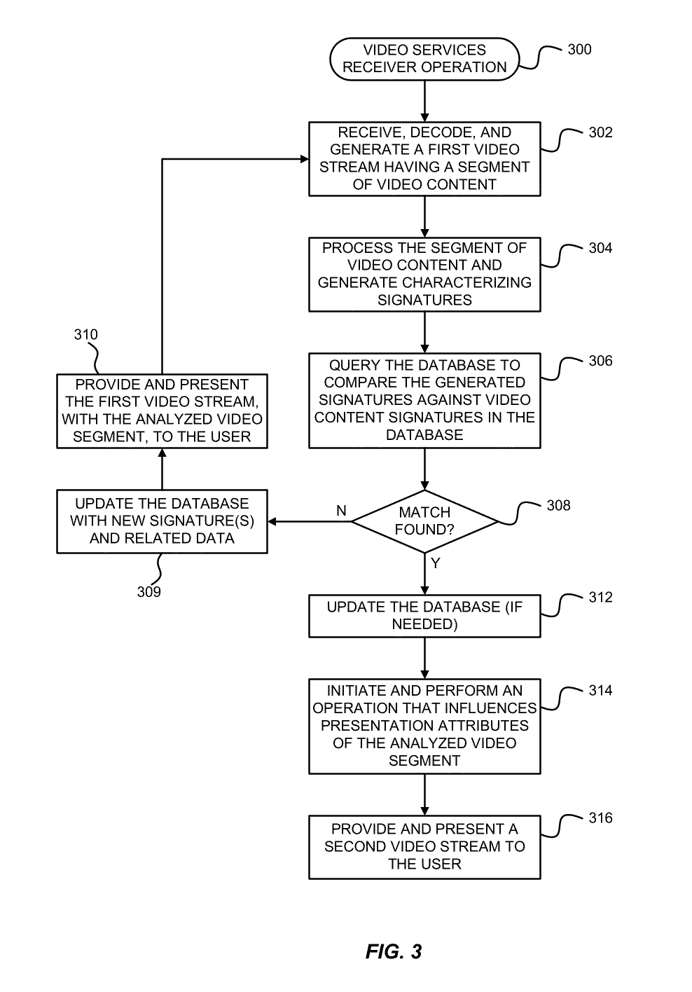

FIG. 2 is a schematic representation of an embodiment of a video services receiver 200 suitable for use in the video services broadcasting system 100 shown in FIG. 1. The video services receiver 200 is designed and configured for providing recorded, buffered, and non-recorded (i.e., “live”) video content to a user, by way of one or more presentation devices. Accordingly, the video services receiver 200 can be used to receive program content, record program content, and present recorded and non-recorded program content to an appropriate display for viewing by a customer or user. The video services receiver 200 also supports the automatic and intelligent video segment identification and manipulation features presented here, wherein certain segments of a current video stream can be identified on the fly for purposes of skipping the segments, replacing the segments with alternative video content, or otherwise influencing the presentation attributes of the segments. These video content identification and processing features are described in more detail below with reference to FIG. 3.

The illustrated embodiment of the video services receiver 200 generally includes, without limitation: at least one processor 202; at least one database 204, which may be realized using one or more memory elements having a suitable amount of data storage capacity associated therewith; a receiver interface 206; a display interface 208 for the display; an audio interface 210; a recording module 212; and a remote control transceiver 214. These components and elements may be coupled together as needed for purposes of interaction and communication using, for example, an appropriate interconnect arrangement or architecture 216. It should be appreciated that the video services receiver 200 represents an embodiment that supports various features described herein. In practice, an implementation of the video services receiver 200 need not support all of the enhanced features described here and, therefore, one or more of the elements depicted in FIG. 2 may be omitted from a practical embodiment. Moreover, a practical implementation of the video services receiver 200 will include additional elements and features that support conventional functions and operations.

The processor 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. In particular, the processor 202 may be realized as a microprocessor, a controller, a microcontroller, or a state machine. Moreover, the processor 202 may be implemented as a combination of computing devices, e.g., a combination of a digital signal processor and a microprocessor, a plurality of microprocessors, one or more microprocessors in conjunction with a digital signal processor core, or any other such configuration.

The database 204 may be realized using any number of data storage devices, components, or modules, as appropriate to the embodiment. Moreover, the video services receiver 200 could include a database 204 integrated therein and/or a database 204 that is implemented in an external memory element that is operatively coupled to the video services receiver 200 (as appropriate to the particular embodiment). The database 204 can be coupled to the processor 202 such that the processor 202 can read information from, and write information to, the database 204. In practice, a memory element of the video services receiver 200 could be used to implement the database 204. In this regard, the database 204 could be realized as RAM memory, flash memory, EPROM memory, EEPROM memory, registers, a hard disk, a removable disk, or any other form of storage medium known in the art. In certain embodiments, the video services receiver 200 includes a hard disk, which may also be used to support integrated DVR functions of the video services receiver 200, and which may also be used to implement the database 204.

As schematically depicted in FIG. 2, the database 204 can be used to store recorded content 220 (which may include recorded program content, downloaded video content, replacement or alternative video content to be played in lieu of detected commercials or advertisements, or the like) under the control and management of the recording module 212. The database 204 may also be used to populate and maintain video content signatures and related information associated with one or more segments of video content. In FIG. 2, the signature data 222 is intended to represent the database of video content signatures. As mentioned above, the signature data 222 (or a portion thereof) could be resident at a remote device or storage element that can be accessed by the video services receiver 200. In certain embodiments, the database 204 can be populated with signature data 222 received from at least one other video services receiver (not shown) operated by the particular video services provider. Similarly, the video services receiver 200 could be suitably configured such that other video services receivers have access to the database 204 for purposes of sharing the signature data 222. A cooperative arrangement of video services receivers may be desirable to take advantage of the viewing habits of a large number of customers and to more efficiently populate the database 204 with new information as needed.

The receiver interface 206 is coupled to the customer's satellite antenna, and the receiver interface 206 is suitably configured to receive and perform front end processing on signals transmitted by satellite transponders. In this regard, the receiver interface 206 can receive data associated with any number of services (e.g., video services), on-screen menus, GUIs, interactive programming interfaces, etc. The receiver interface 206 may leverage conventional design concepts that need not be described in detail here. For example, the receiver interface 206 may be associated with a plurality of different tuners (not shown) that enable the video services receiver 200 to process video streams in the background while decoding and presenting another video stream.

The display interface 208 is operatively coupled to one or more display elements (not shown) at the customer site. The display interface 208 represents the hardware, software, firmware, and processing logic that is utilized to render graphics, images, video, and other visual indicia on the customer's display. In this regard, the display interface 208 facilitates the presentation of programs on the display(s) at the customer premises. For example, the display interface 208 is capable of providing graphical interactive programming interfaces for video services, interactive listings of recorded programs, interactive graphical menus, and other GUIs for display to the user. The display interface 208 may leverage conventional design concepts that need not be described in detail here.

The audio interface 210 is coupled to one or more audio system components (not shown) at the customer site. The audio interface 210 represents the hardware, software, firmware, and processing logic that is utilized to generate and provide audio signals associated with the operation of the video services receiver 200. Depending upon the particular embodiment, the audio interface 210 may be tangibly or wirelessly connected to the audio portion of a television or monitor device, or it may be tangibly or wirelessly connected to a sound system component that cooperates with the television or monitor device.

The recording module 212 is operatively coupled to the receiver interface 206 to record program events provided by the incoming services. In practice, the recording module 212 may include, cooperate with, or be realized as hardware, software, and/or firmware that is designed to provide traditional recording and/or buffering features and functions for the video services receiver 200. Accordingly, the recording module 212 may record video programs provided by video services, audio-only programs provided by audio services, or the like. The recording module 212 may also be utilized to record or store replacement video or image content, which can be processed and rendered as needed. As mentioned above, the recording module 212 cooperates with the database 204 to store the recorded content 220 as needed.

The remote control transceiver 214 performs wireless communication with one or more compatible remote devices, such as a remote control device, a portable computer, an appropriately equipped mobile telephone, or the like. The remote control transceiver 214 enables the user to remotely control various functions of the video services receiver 200, in accordance with well-known techniques and technologies. In certain embodiments, the remote control transceiver 214 is also used to wirelessly receive requests that are related to the generation, display, control, and/or operation of recorded program listings. For example, the remote control device 113 (see FIG. 1) could be used to initiate a playback command to request playback of a recorded program.

The content detection and identification techniques presented here rely on audio/video content signatures. As used here, a content signature is a relatively simple data representation of an amount of audio or video content, wherein the data representation is generated in accordance with an agreed upon algorithm or protocol that provides a repeatable output whenever the same amount of video content is analyzed. A video content signature could be generated from any measurable or detectable “quantity” of video data. In practical implementations, therefore, one frame of video data is the minimum amount of information that can be used to generate a video content signature. In certain embodiments, however, more than one frame of video data could be utilized to generate each video content signature. Accordingly, the amount of video content that forms the basis for one video content signature may vary from one embodiment to another. Moreover, the amount of video content that forms the basis for one video content signature may vary from one video segment of interest to another.

In certain embodiments, a well-defined piece of video content may have an overall or global video content signature associated therewith, in addition to a plurality of additional signatures that correspond to shorter sub-segments of the video content. For example, a thirty second segment of video content (e.g., a commercial or an advertisement) may include thirty contiguous and sequential one-second sub-segments that collectively represent the entire segment. Each of these sub-segments may have a characterizing signature that identifies that particular sub-segment. Alternatively, or additionally, the same segment of video content could be parsed into six different five-second sub-segments that sequentially follow each other, wherein each of the six sub-segments also has a corresponding signature associated therewith. Thus, a given segment of video content may have any number of sub-segments (of the same or different lengths) with corresponding characterizing signatures. It should be appreciated that the “length” of a video segment or a sub-segment need not be expressed in units of time. In certain implementations, the length of a segment or sub-segment may be defined by a number of video frames, an amount of data, or the like.

The specific technique, algorithm, or methodology used to generate characterizing signatures may be chosen to suit the needs of the given application. In practice, signatures should be generated in an efficient and simple manner that allows the host system to quickly and accurately calculate signatures on the fly while handling the video stream in which the analyzed video content appears. Moreover, the algorithm or methodology that generates the characterizing signatures should be designed or chosen such that it is resilient to errors and minor variations in the video content due to transmission differences. In accordance with one preferred embodiment, a characterizing signature is realized as a number that is large enough to distinguish one video segment (or sub-segment) from another. The number represents a simplified, distilled, reduced, or transformed version of the actual video data that is used to render and display the video segment or sub-segment.

In accordance with certain embodiments, each characterizing signature is generated based on the closed captioning data that is associated with the particular segment or sub-segment under analysis. For example, the characterizing signature of a five-second length of video content may be calculated from some or all of the closed captioning text information that is displayed in association with that five-second segment. The specific algorithm utilized to transform the closed captioning data into a corresponding signature may vary from one implementation to another.

In accordance with some embodiments, each characterizing signature may be generated based on the video histogram data associated with the particular segment of sub-segment under analysis. In this context, the histogram data may be associated with the tonal distribution in the video image on a frame-by-frame basis, or associated with the tonal distribution of any number of frames. Alternatively, or additionally, the histogram data may be associated with the distribution of colors in the video image (e.g., RGB values). The actual histogram values can be processed, reduced, hashed, or otherwise transformed to obtain the characterizing signatures that identify the video segments or sub-segments.

In accordance with other embodiments, each characterizing signature may be generated based on the pixel luminance data associated with the particular segment of sub-segment under analysis. In this context, the pixel luminance data may be expressed as an average luminance value of a frame, a distribution of luminance values for a frame, or the like. The raw pixel luminance information can be processed, reduced, hashed, or otherwise transformed to obtain the characterizing signatures that identify the video segments or sub-segments.

For audio content, each characterizing signature could be generated based on associated closed captioning data (if available), volume information, frequency information, or the like. The specific algorithm utilized to transform audio information into a corresponding signature may vary from one implementation to another.

Regardless of the signature generating approach used by the video services receiver, the generation of the characterizing signatures is accomplished in a very quick and efficient manner. This allows the video services receiver to accurately characterize and identify pieces of video content in substantially real-time during presentation of a video stream or while the video stream is being recorded. This also allows the video services receiver to quickly process video content to identify desired segments of the content at any time, e.g., as a background process. As explained in more detail below, the characterizing signatures are generated and compared to a database of stored signatures to determine whether or not the generated signatures have been previously recorded.

It should be appreciated that other techniques and methodologies could be utilized to obtain characterizing signatures that identify or define the segments and sub-segment of video content. The examples provided here are not intended to be limiting or exhaustive, and those of ordinary skill in the art will appreciate that the original video data can be reduced or transformed in any suitable manner to obtain the characterizing signatures.

In accordance with certain embodiments, the system 100 (FIG. 1) and the video services receiver 200 (FIG. 2) can be used to analyze a video stream during playback and presentation to a user. The video stream is analyzed in substantially real time during the playback operation to detect the occurrence of video segments of interest, e.g., commercials, advertisements, or other forms of interstitial content. In accordance with some embodiments, the system 100 and the video services receiver 200 can be used to analyze a video stream as it is being recorded. In accordance with other embodiments, the system 100 and the video services receiver 200 can be used to analyze and characterize a recorded video stream in an offline manner, such that the pre-characterized recorded video stream can be played back in the future. The video services receiver is suitably configured to generate at least one characterizing signature for the content conveyed in the video stream, compare the generated signature(s) to the contents of a database of video content signatures, and take appropriate action if the results of the comparison satisfy predetermined matching criteria. In this regard, the database of video content signatures is populated with the signatures of video segments that are known to be commercials or advertisements, or are otherwise flagged as such. Moreover, the database can be maintained in a current state by adding new signatures as needed when newly analyzed video content is determined to satisfy certain threshold criteria for flagging the video content as being commercial content, an advertisement, or the like.

As mentioned above, the video services receiver may include or cooperate with at least one database of video content signatures. The database may include any number of entries corresponding to any number of different video segments of interest. Each entry in the database contains at least one characterizing signature that uniquely identifies that particular video segment. In certain preferred embodiments, each entry in the database contains a plurality of characterizing signatures such that the video segment can be identified by its sub-segments. Thus, if an entry in the database corresponds to a thirty-second video segment (the length of a typical commercial) having 1800 video frames (i.e., 60 frames per second), then the entry may include any number of signatures for purposes of identifying the sub-segments of the video segment. If each frame has an associated signature, then the entry for this particular example can include up to 1800 signatures. If, however, each signature is defined to be representative of five seconds of video content (300 video frames), then the entry can include signatures that correspond to all possible five-second (or 300 frame) sub-segments of the video segment of interest. Note that a given piece of video content could be represented in terms of sub-segments having different frame lengths, if so desired. For example, an entry in the database may contain “high resolution” signatures corresponding to each individual video frame, any number of “intermediate resolution” signatures, each corresponding to a relatively low number of video frames, and any number of “low resolution” signatures, each corresponding to a relatively high number of video frames. The video segment of interest should be parsed and characterized in a manner that enables the video services receiver to accurately and efficiently identify video content segments regardless of where (i.e., which video frame) the receiver begins its analysis of the video data. Proper characterization of the video content segments enables the video services system to identify the video content segments during playback, regardless of when the video services system tunes to or otherwise accesses the video content segments.

Each entry in the database may also include data that is related to the corresponding video segment, the sub-segments, the video services system, or the like. For example, an entry in the database may include, without limitation, any or all of the following information: (1) a current count that indicates the number of times the video services receiver has identified the corresponding video segment; (2) statistics related to the channel, network, station, and/or or service provider that broadcast or provided the corresponding video segment; (3) the length (in time, video frames, or the like) of the corresponding video segment; (4) statistics related to when the corresponding video segment was broadcast or received, e.g., the day of the week, the month, the season, the time of the day, etc.; (5) the frequency of detection of the corresponding video segment; (6) a time/date stamp that indicates the last time the video segment was detected; (7) metadata associated with the video segment of interest, which may be provided in association with the video content itself; (8) keywords extracted from closed captioning data; and (9) viewer response or command data, e.g., whether content was paused, fast forwarded, skipped, watched repeatedly, etc.

The database of video content signatures is maintained and populated with entries that correspond to certain flagged segments of video content. In other words, the database is populated for the video segments of interest that are to be identified going forward. For example, the database may be populated only with entries for commercials, advertisements, or other interstitial video content. Conversely, the host system may be suitably configured such that the database is not populated with entries corresponding to certain types of programming content, e.g., movies, network shows or programs, infomercials, or the like. The database could be seeded with any number of entries if the associated video content can be accurately characterized (i.e., the signatures can be calculated and saved) in advance. Whether or not the database includes any initial entries, it is preferably populated and updated in an ongoing manner during operation of the video services receiver. For example, video content can be analyzed by generating characterizing signatures on the fly during presentation of the video content to a user. If the video services receiver determines that the generated signatures do not match with the signatures of any current entries in the database, then a new entry can be created. Thereafter, the new entry can be updated or modified whenever the video services receiver subsequently generates signatures that match those found in the new entry.

In certain embodiments, one or more tuners of the video services receiver can be used in the background to receive and analyze video streams for purposes of identifying new video segments of interest and/or to gather statistics for video segments that already appear in the database. Thus, one or more tuners (which are not currently being used to present video content to the user) can “scan” different video services and channels in an attempt to identify video content that might be candidates for inclusion in the signature database. This type of background processing may also be desirable to increase the accuracy and characterization of existing entries in the database.

FIG. 3 is a flow chart that illustrates an exemplary embodiment of a process 300 of operating a video services receiver. The various tasks performed in connection with the process 300 (and with the other processes described herein) may be performed by software, hardware, firmware, or any combination thereof. For illustrative purposes, the description of a process may refer to elements mentioned above in connection with FIG. 1 and FIG. 2. Moreover, portions of the process 300 may be performed by different elements of the described system, e.g., a processing module, a software component, or a functional element of a video services receiver. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the illustrated process as long as the intended overall functionality remains intact.

This description of the process 300 assumes that at least one suitably arranged database of video content signatures has already been established and populated in accordance with the approaches described above, and that the video services receiver includes or otherwise has access to the at least one database. The illustrated embodiment of the process 300 may begin at any time when the video services receiver is currently tuned to an ongoing program event or is presenting a previously recorded program event. Accordingly, the process 300 may receive, decode, and generate a first video stream for presentation to a user (task 302). The first video stream may include any number of program segments and/or any number of interstitial video segments (e.g., commercials or advertisements). For this particular example, it is assumed that the first video stream contains a segment of video content to be analyzed.

While the first video stream is being presented for rendering on a display element, the process 300 continues by processing and analyzing the current segment of video content (task 304). More specifically, task 304 generates at least one characterizing signature for the current segment of video content. In accordance with this example, the process 300 generates characterizing signatures for a plurality of contiguous sub-segments of the current segment of video content. As mentioned above, one or more signatures for a segment of video content will be effective at uniquely defining and identifying that piece of video content. The characterizing signatures may be generated based on the closed captioning data that is associated with the current segment of video content, based on histogram data associated with the current segment of video content, based on pixel luminance data associated with the current segment of video content, or the like.

The process 300 may continue by querying the database to compare the generated signatures against the video content signatures in the database (task 306). In this regard, the process may use one or more of the generated signatures in a query that is issued for the database. If the results of the comparison do not satisfy the predetermined matching criteria used by the video services receiver (the “No” branch of query task 308), then the process 300 updates the database (task 309) to populate it with the new signature or signatures, along with any related data that is associated with the signature data, the corresponding video content, etc. Task 309 enables the video services receiver to self-populate the database as it receives and analyzes new video content. Accordingly, if the process 300 experiences “unknown” video content having unfamiliar signatures that do not match the stored signatures, the process 300 adds those signatures to the database for purposes of subsequent comparisons. After updating the database in this manner, the process 300 continues in a typical manner by providing and presenting the first video stream, which includes the current segment of video content, to the user (task 310). In practice, task 310 may lead back to task 302 such that the first video stream can be analyzed in an ongoing manner.

If the results of the comparison satisfy the predetermined matching criteria (the “Yes” branch of query task 308), then the process 300 may update the database of video content signatures if needed or desirable to do so (task 312). For example, the entry that includes the detected segment of video content may be updated to reflect that the video segment has been identified again. Moreover, related data could be added or updated to the database entry, e.g., the time of detection, the channel or station that broadcast the detected segment, or the number of sub-segments that were analyzed before the segment was identified. When the current segment of video content is identified in the database, the process 300 initiates and performs an operation, function, or action that influences the presentation attributes of the detected segment of video content (task 314), and provides and presents a second video stream to the user (task 316), wherein the second video stream represents an altered version of the first video stream.

In connection with task 314 and task 316, the video services receiver may replace at least a portion of the identified segment of video content with a segment of alternative video content. Thus, if the process 300 detects the occurrence of a commercial that has been presented multiple times already, it may access stored alternative video content and insert the alternative video content into the video stream (in lieu of the detected video segment). The alternative video content may be a preview to an upcoming program event, a personal slide show, or a different advertisement provided by the video services provider. As another example, when a match is found (the “Yes” branch of query task 308), then the process 300 may command the video services receiver to automatically skip or fast forward through at least a portion of the detected segment of video content. As yet another example, the process 300 may command the video services receiver to remove or omit at least a portion of the detected segment of video content from the first video stream, such that the second video stream no longer includes the entirety of the detected segment of video content. Conversely, if the process 300 detects the occurrence of an advertisement that has been flagged or marked as being important, valuable, or “untouchable”, then the video services receiver may be controlled such that the detected segment cannot be skipped or fast forwarded, or such that the channel cannot be changed until after the detected segment has been presented. As yet another example, when a match is found, the process 300 may command the video services receiver to automatically begin scanning through other channels (which may be preselected as preferred or favorite channels of the user) for the remaining duration of the detected commercial. Thus, the techniques described here could be utilized to initiate an automated “channel surfing” feature for the user.

For ease of description, FIG. 3 depicts process 300 in a stepwise manner. In practice, however, the generation of signatures, the searching of the signature database, and the determination of whether the comparison has satisfied the matching criteria need not be performed in the exact manner shown in FIG. 3. For example, in certain embodiments, a plurality of contiguous sub-segments of the current segment of video content can be processed in a sequential manner, and as needed until a match has been found (or until the process 300 has determined that no matching entry exists in the signature database). In accordance with this approach, an initial sub-segment is processed to generate a corresponding signature (Signature 1). The database can then be searched for the presence of Signature 1. If no entry in the database contains Signature 1, then the process 300 may continue in an appropriate manner. If, however, at least one entry in the database contains Signature 1, then the process 300 may continue by generating another signature (Signature 2) that identifies the next sub-segment of the current video segment. Thereafter, the database can be searched to determine whether any entry contains Signature 1 followed by Signature 2. This approach can be repeated any number of times to eliminate potential matches, until the sequence of signatures (for a plurality of contiguous sub-segments) uniquely points to only one entry in the database. This approach may be desirable to contemplate a scenario where sub-segments from different pieces of video content result in identical signatures.

Referring again to query task 308, the process 300 may use any matching criteria to determine whether or not the process 300 finds a hit in the signature database. In accordance with some embodiments, query task 308 determines that there is a match if the generated signature(s) are found in the database. In alternative embodiments, other checks must be satisfied before the process 300 determines that the current video segment matches video content in the database. For example, the matching criteria may require that the video segment under analysis must have a certain length, e.g., less than 45 seconds, more than 15 seconds, less than 60 seconds, or the like. As another example, the matching criteria may require that the video segment under analysis has been detected more than a threshold number of times before a match is declared. As yet another example, the matching criteria may require that the video segment under analysis has been detected across a number of different channels.

Moreover, the video services receiver may support various filtering and/or safeguarding techniques to reduce the number of false matches. For example, the database could be trained such that it only gets populated with video content that is likely to be commercials or advertisements, and such that it does not get populated with network programming, movies, or syndicated or repeated content that might appear on more than one channel. As another example, the video services receiver could be suitably configured to delete old entries from the database to improve performance and make searching more efficient. In this regard, entries that have not been queried with generated characterizing signatures for a long period of time may be purged, under the assumption that the segments of video content are no longer being broadcast or played back at a sufficiently high frequency.

Notably, the video segment identification technology presented here is effective at recognizing certain types of interstitial video content on the fly, even during live broadcast presentation of a video stream. In practice, therefore, a brief excerpt of the video content of interest may need to be presented or processed before the video services receiver can accurately determine that the video content represents a commercial that appears in the database. For instance, the first two or five seconds of a commercial may appear before the designated action takes over.

The foregoing description of the process 300 assumes that the video stream of interest is analyzed during presentation of that video stream. Alternatively, the video stream of interest could be processed in an equivalent manner while it is being recorded (whether or not it is being decoded for presentation). In accordance with another possible operating scenario, the video stream of interest could be processed in an equivalent manner after it has been recorded, and during an “idle” time when the video stream is not being decoded for presentation. Accordingly, tasks 302 and 310 may be omitted in certain practical situations.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of operating a video services receiver, the method comprising:
providing a first video stream for presentation to a user, the first video stream comprising a segment of video content;
processing the segment of video content to generate at least one characterizing signature that uniquely identifies the segment of video content;
using the at least one characterizing signature in a query against a database of video content signatures;
presenting the first video stream, including the segment of video content, when the query does not find the at least one characterizing signature in the database of video content signatures; and
presenting a second video stream when the query finds the at least one characterizing signature in the database of video content signatures, wherein the second video stream represents an altered version of the first video stream.

2. The method of claim 1, wherein:
the at least one characterizing signature comprises a plurality of characterizing signatures; and
each of the characterizing signatures identifies a respective sub-segment of the segment of video content.

3. The method of claim 1, wherein the processing step generates the at least one characterizing signature based on closed captioning data associated with the segment of video content.

4. The method of claim 1, wherein the processing step generates the at least one characterizing signature based on histogram data associated with the segment of video content.

5. The method of claim 1, wherein the processing step generates the at least one characterizing signature based on pixel luminance data associated with the segment of video content.

6. The method of claim 1, wherein the step of presenting the second video stream comprises:
replacing at least a portion of the segment of video content with a segment of alternative video content.

7. The method of claim 1, wherein the step of presenting the second video stream comprises:
removing at least a portion of the segment of video content from the first video stream.

8. The method of claim 1, further comprising:
populating the database of video content signatures with entries corresponding to segments of video content.

9. The method of claim 8, wherein the flagged segments of video content represent advertisements or commercials.

10. A method of operating a video services receiver, the method comprising:
receiving a segment of video content;
processing a plurality of contiguous sub-segments of the segment of video content to generate a corresponding plurality of characterizing signatures, wherein each of the characterizing signatures identifies a respective one of the contiguous sub-segments;
comparing the characterizing signatures to video content signatures maintained in a database; and
when results of the comparing satisfy predetermined matching criteria, initiating an operation that influences presentation attributes of the segment of video content.

11. The method of claim 10, wherein, when results of the comparing satisfy the predetermined matching criteria, the video services receiver replaces at least a portion of the segment of video content with a segment of alternative video content.

12. The method of claim 10, wherein, when results of the comparing satisfy the predetermined matching criteria, the video services receiver skips at least a portion of the segment of video content.

13. The method of claim 10, further comprising:
populating the database with entries corresponding to flagged segments of video content.

14. The method of claim 13, wherein the flagged segments of video content represent advertisements or commercials.

15. The method of claim 10, further comprising:
providing the segment of video content to a presentation device, wherein the processing and comparing steps are performed concurrently with the providing step.

16. A video services receiver comprising:
a receiver interface to receive data associated with video services, including a first video stream comprising a segment of video content;
a display interface for a display operatively coupled to the video services receiver, the display interface facilitating presentation video streams on the display; and
a processor coupled to the receiver interface and the display interface, wherein the processor generates at least one characterizing signature that identifies the segment of video content, compares the at least one characterizing signature against video content signatures maintained in a database to obtain comparison results, and initiates an operation that influences presentation attributes of the first video stream when the comparison results satisfy predetermined matching criteria.

17. The video services receiver of claim 16, wherein the database resides at the video services receiver.

18. The video services receiver of claim 16, wherein:
when the comparison results satisfy the predetermined matching criteria, the processor replaces at least a portion of the segment of video content with a segment of alternative video content, resulting in a second video stream that contains the alternative video content; and
the display interface facilitates presentation of the second video stream on the display.

19. The video services receiver of claim 16, wherein the database is populated with entries corresponding to flagged segments of video content.

20. The video services receiver of claim 19, wherein the flagged segments of video content represent advertisements or commercials.
